(19) United States
(12) Patent Application Publication
(10) Pub. No.: US 2022/0136590 A1
(43) Pub. Date: May 5, 2022

(54) STEPLESS SPEED CHANGER APPLIED TO CVT GEARBOX

(71) Applicant: Shenzhen Rui Pengfei Mold Co., Ltd, Shenzhen (CN)

(72) Inventors: Geqi QI, Shenzhen (CN); Zefeng LAI, Shenzhen (CN)

(21) Appl. No.: 17/327,710

(22) Filed: May 22, 2021

(30) Foreign Application Priority Data
Oct. 30, 2020 (CN) 202011191846.X

(51) Int. Cl. F16H 9/18; F16H 61/662

(52) U.S. Cl. CPC F16H 9/18; F16H 61/66259

(57) ABSTRACT

A stepless speed changer applied to a CVT gearbox is provided which comprises a speed changing mechanism, a clamping mechanism, and a speed regulating mechanism, and the speed changing mechanism is mounted on a shaft body and connected with a power input mechanism and a power output mechanism respectively along both sides of the shaft body; the clamping mechanism is distributed along an axial direction of the shaft body and located at both sides of the speed changing mechanism, and the clamping mechanism guarantees the speed changing mechanism transmits a torque normally by use of pressurization of a first hydraulic system; the speed regulating mechanism is located at a radial end of the shaft body and combined with the speed changing mechanism, and the speed regulating mechanism achieves speed change of the speed changing mechanism by use of acceleration and deceleration control of a second hydraulic system, which solves the structural problems of the existing CVT gearbox, for instance, low input torque, limited speed-change range, high cost and the like. With a steel-ring friction pair replacing a chain-steel belt drive friction pair, both cost and manufacture difficulty are greatly lowered.

### CROSS-REFERENCE TO RELATED APPLICATIONS

This application claims priority to Chinese Patent Application No. 202011191846.X with a filing date of Oct. 30, 2020. The content of the aforementioned application, including any intervening amendments thereto, are incorporated herein by reference.

### TECHNICAL FIELD

The present disclosure relates to the technical field of a stepless speed changer, in particular to a stepless speed changer applied to a continuously variable transmission (CVT) gearbox.

### BACKGROUND

The existing CVT stepless speed changing mechanism refers to a mechanical stepless speed changing transmission mechanism. Although the mechanical stepless speed changing transmission mechanism is numerous in type, it, as a necessary functional mechanism, is generally comprised by a transmission mechanism, a pressurization device and a speed regulating mechanism, respectively functioning as stepless speed change, pressurization and speed regulation. The present invention aims to provide a stepless speed changer applied to a CVT gearbox to improve and overcome the defects (e.g., low driving torque, short service life and limited gear ratio) of the existing CVT gearbox. These defects are mainly related to the failure mode of a speed changing mechanism of a stepless speed changer.

The main failure mode of the existing CVT is resulted from wear of the speed changing mechanism of a stepless speed changer. Such wear includes surface contact fatigue, adhesive wear (comprising adhesion) and abrasive wear (this often occurs at the early run-in period of a product, and is a non-main failure mode of the CVT).

Except for non-structural factors (including working condition, roughness, stiffness, lubricity, temperature and the like) of a friction pair structure, contact stress (in a static or dynamic state), rolling (sliding) linear velocity, number of stress cycles, non-continuous contact and tangential force belong to the structural factors relevant to wear failure. In these structural factors, the magnitude of the contact stress is vital, and lowering the contact stress to improve the driving torque and prolong the service life is the main pursuit. If the contact stress cannot be reduced by making structural improvements, it is often to lower the driving torque (i.e., lowering the contact stress of the friction pair) in the actual product design process so as to ensure product life, which is the main reason as to why the driving torque of the CVT is low and difficult to raise.

### SUMMARY

It is the objects of the present invention to overcome the existing defects of the prior art and provide a stepless speed changer applied to a continuously variable transmission (CVT) gearbox for solving the structural problems of the existing CVT gearbox, for instance, low input torque, limited speed-change range, high cost and the like. In the present invention, a steel-ring friction pair replaces a chain-steel belt drive friction pair, so that both cost and manufacture difficulty are greatly lowered, and the CVT gearbox with its property greatly improved to a higher level, is applicable to more fields covering those of automatic transmission (AT) gearboxes.

To achieve the above objects, the present invention adopts the following technical solution: a stepless speed changer comprises a speed changing mechanism, a clamping mechanism, and a speed regulating mechanism, and the speed changing mechanism is mounted on a shaft body and connected with a power input mechanism and a power output mechanism respectively along both sides of the shaft body; the clamping mechanism is distributed along an axial direction of the shaft body and located at both sides of the speed changing mechanism, and the clamping mechanism guarantees that the speed changing mechanism transmits a torque normally by use of pressurization of a first hydraulic system; the speed regulating mechanism is located at a radial end of the shaft body and combined with the speed changing mechanism, and the speed regulating mechanism achieves speed change of the speed changing mechanism by use of acceleration and deceleration control of a second hydraulic system.

Preferably, the speed changing mechanism comprises an intermediate rolling body, an input frictional ring, an output frictional ring and an input flange and an output flange both mounted on the shaft body, a radial end face of the input frictional ring is clamped between a radial end face of the intermediate rolling body and an annular groove disposed on the input flange, a radial end face of the output frictional ring is clamped between the radial end face of the intermediate rolling body and an annual groove disposed on the output flange, and the input frictional ring and the output frictional ring are pressed between the annular grooves of the input flange and the output flange and the intermediate rolling body by the clamping mechanism.

Preferably, the intermediate rolling body is of a split structure comprising an input pyramid wheel, an output pyramid wheel and a splined cylinder liner, inner walls of the input pyramid wheel and the output pyramid wheel are provided with one turn of spline teeth respectively, and the input pyramid wheel and the output pyramid wheel are connected into one piece by connection of the spline teeth and the splined cylinder liner.

Preferably, the annular grooves disposed on the input flange and the output flange are equal in diameter, and an outer diameter of a conical section of the input pyramid wheel in contact with the input frictional ring is smaller than an outer diameter of a conical section of the output pyramid wheel in contact with the output frictional ring.

Preferably, the clamping mechanism comprises a pressurization chamber and a pressure disk mounted on the shaft body, the pressurization chamber is formed by sealingly assembling the pressure disk and the output flange and fixedly connecting the pressure disk and the output flange by a thrust bearing and a bearing nut; the pressurization chamber is in communication with a hydraulic opening disposed on a radial wall of the shaft body, the hydraulic opening is in communication with a hydraulic control opening disposed on a through hole through the through hole disposed on a shaft core of the shaft body, and the hydraulic control opening is controlled by the first hydraulic system.

Preferably, the thrust bearing is mounted on the shaft body and comprises a left thrust bearing and a right thrust bearing, the left thrust bearing is limited at an input flange end, and the right thrust bearing is mounted at a pressure disk end through a bearing bracket and fixed through the bearing nut.

Preferably, the speed regulating mechanism comprises an outer ring bracket, an inner hub bracket and a piston shaft, the inner hub bracket is mounted on the shaft body, the outer ring bracket is mounted inside a housing, the piston shaft is penetrated through the intermediate rolling body shaft core, fixed between the outer ring bracket and the inner hub bracket by a bolt, and distributed in the form of an umbrella frame between the outer ring bracket and the inner hub bracket.

Preferably, the piston shaft is of cam shaft structure and divides the interior of the intermediate rolling body into a deceleration control chamber and an acceleration control chamber; one end of the piston shaft is provided with a mounting hole for mounting of a cartridge valve, an internal channel of the cartridge valve is in communication with the deceleration control chamber, and an acceleration control channel between the cartridge valve and the mounting hole is in communication with the acceleration control chamber.

Preferably, an acceleration control hydraulic opening in communication with the acceleration control chamber and a deceleration control hydraulic opening in communication with the deceleration control chamber are disposed on an outer wall of the outer ring bracket, each intermediate rolling body corresponds to one acceleration control hydraulic opening and one deceleration control hydraulic opening, and the control hydraulic openings are distributed annularly.

Preferably, two annular recesses are disposed on the outer wall of the outer ring bracket and isolated from an inner wall of the housing by three seals; the two annular recesses correspond to the annularly-arranged acceleration control hydraulic opening and deceleration control hydraulic opening respectively, the housing is provided with an acceleration control fluid interface and a deceleration control fluid interface in respective communication with the two annular recesses, and the interfaces are controlled by the second hydraulic system.

The stepless speed changer applied to a continuously variable transmission (CVT) gearbox provided by the present invention has the beneficial effects that: (i) as compared to the parallel-shaft speed changing mechanism of the existing CVT, in case of the same gear ratio, a straight-shaft speed changing mechanism is compact in structure; (ii) as compared to the existing CVT friction pair (including a chain and a steel belt), by adopting a uniform steel-ring mechanism, the speed changing mechanism is simple in structure, therefore cost is low, manufacture process is simple, resistance to contact fatigue and adhesion is high, and service life is long; (iii) as compared to the existing CVT, due to independent control and speed regulation, the speed regulating mechanism is simple to control, easy for optimization of power control, free of mutual interference between clamping and speed regulation, high in reliability, and low in speed regulation control pressure; and (iv) as compared to the existing CVT, due to clamping with an independent clamping mechanism, the speed regulating mechanism is reliable and accurate to control and pressurize so as to lower ineffective contact stress and improve product life.

### BRIEF DESCRIPTION OF THE DRAWINGS

FIG. 1 is a schematic diagram of a three-dimensional structure of the present invention.

FIG. 2 is a front view of a cross-section structure of the present invention.

FIG. 3 is a front view of a cross-section structure showing a whole speed regulating mechanism of the present invention.

FIG. 4 is an exploded view of an intermediate rolling body of the present invention.

FIG. 5 is a first and second hydraulic control schematic diagram.

In the drawings, the reference signals denote that: 1 input spline; 2 input flange; 3 input frictional ring; 4 input pyramid wheel; 5 output pyramid wheel; 6 output frictional ring; 7 output flange; 8 output spline; 9 shaft body; 10 left thrust bearing; 11 pressure disk; 12 right thrust bearing; 13 bearing nut; 14 outer ring bracket; 15 inner hub bracket; 16 piston shaft; 17 splined cylinder linear; 18 cartridge valve; 19 bolt; 20 hydraulic control opening; 21 hydraulic opening; 22 pressurization chamber; 23 deceleration control chamber; 24 acceleration control chamber; 25 deceleration control hydraulic opening; 26 acceleration control hydraulic opening; 27 acceleration control channel; 28 deceleration control chamber hydraulic opening; 29 acceleration control chamber hydraulic opening; 30 housing; 31 speed changing mechanism; 32 clamping mechanism; 33 speed regulating mechanism; 34 intermediate rolling body; 35 annular groove; 36 spline teeth; 37 through hole; 38 bearing bracket; 39 annular recess; 40 seal; 41 acceleration control fluid interface; 42 deceleration control fluid interface; 43 first hydraulic system; 44 second hydraulic system.

### EMBODIMENTS

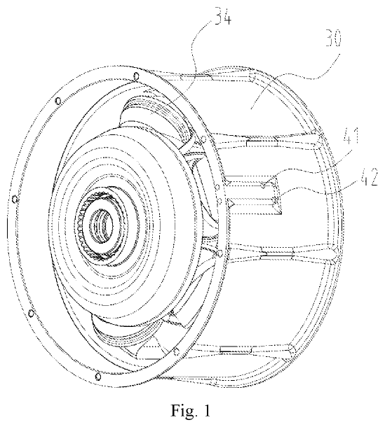

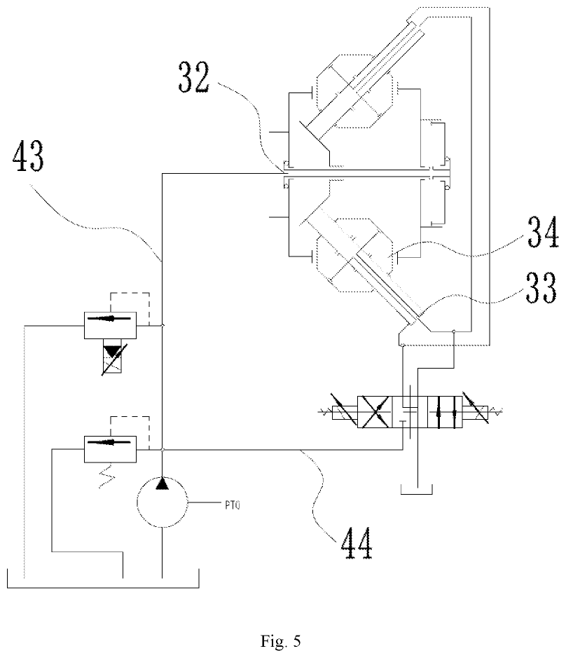

The present invention will be described in detail in the following embodiments with reference to the appended drawings: as shown in FIGS. 1 to 5, a stepless speed changer applied to a continuously variable transmission (CVT) gearbox provided by the present invention, comprises a speed changing mechanism 31, a clamping mechanism 32, and a speed regulating mechanism 33, and the speed changing mechanism 31 is mounted on a shaft body 9 and connected with a power input mechanism and a power output mechanism respectively along both sides of the shaft body 9; the clamping mechanism 32 is distributed along an axial direction of the shaft body 9 and located at both sides of the speed changing mechanism 31, and the clamping mechanism 32 guarantees that the speed changing mechanism 31 transmits a torque normally by use of pressurization of a first hydraulic system 43; the speed regulating mechanism 33 is located at a radial end of the shaft body 9 and combined with the speed changing mechanism 31, and the speed regulating mechanism 33 achieves speed change of the speed changing mechanism 31 by use of acceleration and deceleration control of a second hydraulic system 44. To solve the structural problems of the existing CVT gearbox, for instance, low input torque, limited speed-change range, high cost and the like, a steel-ring friction pair replaces a chain-steel belt drive friction pair, so that both cost and manufacture difficulty are greatly lowered, and the CVT gearbox with its property improved to a higher level, is applicable to more fields covering those of automatic transmission (AT) gearboxes. By virtue of the first and second hydraulic control systems, as compared to the existing CVT, due to independent control and speed regulation, the speed regulating mechanism is simple to control, easy for optimization of power control, free of mutual interference between clamping and speed regulation, high in reliability, and low in speed regulation control pressure; and by clamping with an independent clamping mechanism, the speed regulating mechanism is reliable and accurate to control and pressurize so as to lower ineffective contact stress and improve product life.

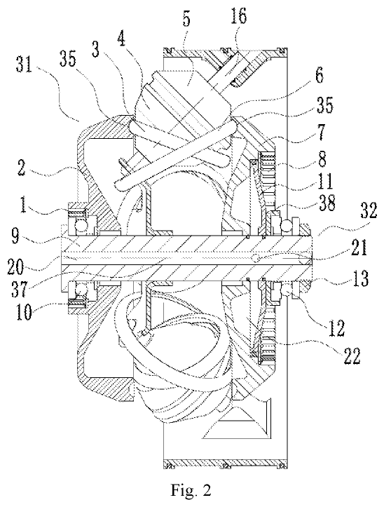

As shown in FIG. 2, the speed changing mechanism 31 comprises an intermediate rolling body 34, an input frictional ring 3, an output frictional ring 6 and an input flange 2 and an output flange 7 both mounted on the shaft body 9; the input flange 2 is connected with an input spline 1, the input spline 1 is mounted on the shaft body 9, the output flange 7 is connected with an output spline 8, and the output spline 8 is mounted on the shaft body 9; a radial end face of the input frictional ring 3 is clamped between a radial end face of the intermediate rolling body 34 and an annular groove 35 disposed on the input flange 2; a radial end face of the output frictional ring 6 is clamped between the radial end face of the intermediate rolling body 34 and an annual groove 35 disposed on the output flange 7, that is, the outer diameters of the input and output frictional rings contact the corresponding annular grooves 35 of the input and output flanges, and the input and output frictional rings roll in the grooves, and meantime, the inner diameters of the input and output frictional rings contact the corresponding conical face of the intermediate rolling body 34, and the input and output frictional rings rotate around the equivalent diameter of a fixed section; the input frictional ring 3 and the output frictional ring 6 are pressed between the annular grooves 35 of the input flange 2 and the output flange 7 and the intermediate rolling body 34 by the clamping mechanism 32; and the diameter of the input frictional ring 3 is smaller than that of the output frictional ring 6, and the input frictional ring 3 is crossed inside the output frictional ring 6 in a non-contact manner.

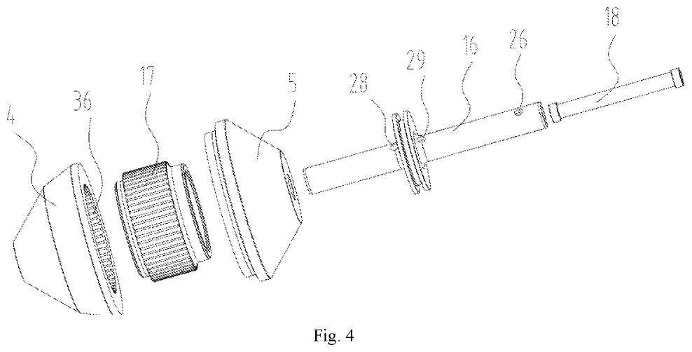

As shown in FIG. 4, the intermediate rolling body 34 is of a split structure comprising an input pyramid wheel 4, an output pyramid wheel 5 and a splined cylinder liner 17, inner walls of the input pyramid wheel 4 and the output pyramid wheel 5 are provided with one turn of spline teeth 36 respectively, and the input pyramid wheel and the output pyramid wheel are connected into one piece by connection of the spline teeth 36 and the splined cylinder liner 17. The quantity of the distributed intermediate rolling bodies 34 is unfixed and determined upon the input torque, gear ratio and minimum allowable outer diameter of the outer ring bracket 14.

The annular grooves 35 disposed on the input flange 2 and the output flange 7 are equal in diameter, that is, the rolling tracks of the input frictional ring and the output frictional ring are equal in diameter and coaxial, so that a capsizing force of the intermediate rolling body is prevented under the effect of a clamping force; and an outer diameter of a conical section of the input pyramid wheel 4 in contact with the input frictional ring 3 is smaller than an outer diameter of a conical section of the output pyramid wheel 5 in contact with the output frictional ring 6.

The above speed changing mechanism is improved to a speed-raising type from a speed-change symmetrical type (i.e., the intermediate rolling body is changed into a unsymmetrical structure), therefore, when the gear ratio and output torque are kept unchanged, the speed-raising mechanism contributes to greatly improving the input torque (the CVT core performance parameter) by over 1.5 times; the steel-ring friction pair (including an input frictional ring and an output frictional ring) is of crossed structure formed by rings of different sizes, and by use of the unsymmetrical structure of the intermediate rolling body, the inner diameter of the steel ring is changed to be more adaptive to the outer dimeter of the intermediate rolling body so as to lower contact stress and improve driving torque, lower number of stress cycles and reduce rolling speed so as to improve resistance to adhesion and contact fatigue, and get a higher gear ratio with a same structural space. The speed changing mechanism plays the main role in changing the driving torque and gear ratio through power transmission with a frictional force. The speed changing mechanism of the present patent features a pyramid steel-ring disk type structure, and a central axis-based speed-raising type transmission form.

The power transmission order is: the input spline 1→the input flange 2→the input frictional ring 3→the input pyramid wheel 4→the output pyramid wheel 5→the output frictional ring 6→the output flange 7→the output spline 8.

The speed changing mechanism is as follows: the input pyramid wheel 4, the output pyramid wheel 5 and the splined cylinder linear 17 constitute the intermediate rolling body that rotates around the piston shaft 16, axially moves and respectively clamps and contacts the input frictional ring 3 and the output frictional ring 6. The conical contact equivalent radius ratio of the intermediate rolling body is the gear ratio of the speed changing mechanism.

The clamping mechanism 32 comprises a pressurization chamber 22 and a pressure disk 11 mounted on the shaft body 9, the pressurization chamber 22 is formed by sealingly assembling the pressure disk 11 and the output flange 7 and fixedly connecting the pressure disk 11 and the output flange 7 by a thrust bearing and a bearing nut 13; the pressurization chamber 22 is in communication with a hydraulic opening 21 disposed on a radial wall of the shaft body 9, the hydraulic opening 21 is in communication with a hydraulic control opening 20 disposed on a through hole 37 through the through hole 37 disposed on a shaft core of the shaft body 9, and the hydraulic control opening 20 is controlled by the first hydraulic system 43.

The thrust bearing is mounted on the shaft body 9 and comprises a left thrust bearing 10 and a right thrust bearing 12, the left thrust bearing 10 is limited at an input flange end, and the right thrust bearing 12 is mounted at a pressure disk end through a bearing bracket 38 and fixed through the bearing nut 13.

The clamping mechanism plays the main role in preventing slip among driving friction pairs of the speed changing mechanism and ensuring normal torque transmission of the speed changing mechanism.

A pressurizing force transmission order, namely a hydraulic pressure transmission order is as follows: a pressure controlled by the first hydraulic system→a hydraulic control opening 20 of the clamping mechanism→a hydraulic opening 21 of the pressurization chamber 22→the pressurization chamber 22.

A pressurization transmission order at the input end is: a pressure of the pressurization chamber 22→the pressure disk 11→the bearing 12→the bearing nut 13→the shaft body 9→the left thrust bearing 10→the input flange 2→the input frictional ring 3→the input pyramid wheel 4.

A pressurization transmission order at the output end is: a pressure of the pressurization chamber 22→the output flange 7→the output frictional ring 6→the output pyramid wheel 5.

The pressurization principle works as follows: forces borne by the input pyramid wheel 4 and the output pyramid wheel 5 are equal clamping forces that are opposite in direction, and have ring-closed balanced interior, thus, it is reliable and accurate to control and pressurize so as to lower ineffective contact stress and improve product life.

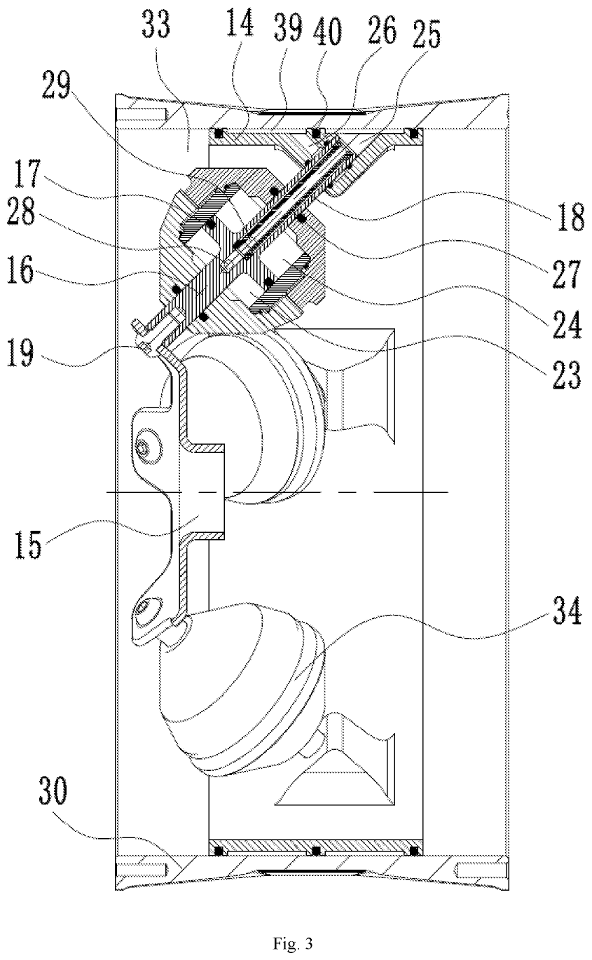

As shown in FIGS. 3 to 4, the speed regulating mechanism 33 comprises an outer ring bracket 14, an inner hub bracket 15 and a piston shaft 16, the inner hub bracket 15 is mounted on the shaft body 9, the outer ring bracket 14 is mounted inside a housing 30, the piston shaft 16 is penetrated through the intermediate rolling body 34 shaft core, fixed between the outer ring bracket 14 and the inner hub bracket 15 by a bolt 19, and distributed in the form of an umbrella frame between the outer ring bracket 14 and the inner hub bracket 15. The intermediate rolling body 34 is actually a two-rod piston hydraulic cylinder; the input pyramid wheel 4 and the output pyramid wheel 5 and the splined cylinder liner 17 are combined and connected into the cylinder body through splines, the cylinder body is clamped between the input frictional ring 3 and the output frictional ring 6 to form a closed cylinder that is prevented from breaking up even under the inner pressure. The cylinder moves up and down along the axial direction of the piston shaft 16 under the effect of the pressure, and the piston shaft 16 also serves as the rotary shaft of the intermediate rolling body 16.

The piston shaft 16 is of cam shaft structure and divides the interior of the intermediate rolling body 34 into a deceleration control chamber 23 and an acceleration control chamber 24; the piston shaft 16 at the deceleration control chamber 23 side is radially provided with a deceleration control chamber hydraulic opening 28, and the piston shaft 16 at the acceleration control chamber 24 side is radially provided with an acceleration control chamber hydraulic opening 29; one end of the piston shaft 16 is provided with a mounting hole for mounting of a cartridge valve 18, an internal channel of the cartridge valve 18 is in communication with the deceleration control chamber 23, and an acceleration control channel 27 between the cartridge valve 18 and the mounting hole is in communication with the acceleration control chamber 24.

An acceleration control hydraulic opening 26 in communication with the acceleration control chamber 24 and a deceleration control hydraulic opening 25 in communication with the deceleration control chamber 23 are disposed on an outer wall of the outer ring bracket 14, each intermediate rolling body 34 corresponds to one acceleration control hydraulic opening 26 and one deceleration control hydraulic opening 25, and the control hydraulic openings are distributed annularly.

Two annular recesses 39 are disposed on the outer wall of the outer ring bracket 14 and isolated from an inner wall of the housing 30 by three seals 40; the two annular recesses 39 correspond to the annularly-arranged acceleration control hydraulic opening 26 and deceleration control hydraulic opening 25 respectively, the housing 30 is provided with an acceleration control fluid interface 41 and a deceleration control fluid interface 42 in respective communication with the two annular recesses 39, and the interfaces are controlled by the second hydraulic system 44.

The speed regulating mechanism plays the main role in changing the conical contact equivalent radii of the input and output ends of the intermediate rolling body so as to achieve speed change.

Speed regulation of a hydraulic control system is carried out in accordance with the following sequence: the second hydraulic system controls the acceleration control fluid interface 41 by speed regulation→the acceleration control hydraulic opening 26, the second hydraulic system controls the deceleration control fluid interface 42 by speed regulation→the deceleration control hydraulic opening 25.

Hydraulic acceleration control is carried out in accordance with the following sequence: the acceleration control hydraulic opening 26→the acceleration control channel 27→the acceleration control chamber hydraulic opening 29→the acceleration control chamber 24.

Hydraulic deceleration control is carried out in accordance with the following sequence: the deceleration control hydraulic opening 25→the internal channel of the cartridge valve 18→the deceleration control chamber hydraulic opening 28→the deceleration control chamber 23.

The speed regulation principle works as follows: by means of a pressure of the deceleration control chamber 23 or acceleration control chamber 24, the speed regulating mechanism enables the intermediate rolling body to overcome a frictional force generated by the clamping force between the input frictional ring 3 and the output frictional ring 6; speed regulation through corresponding up-down movement along the axial direction of the piston shaft 16 lies in movement in the whilst of changing the speed along with the change of the rotary equivalent radii upon contact with the input pyramid wheel and the output pyramid wheel. Meantime, the outer ring bracket 14, the inner hub bracket 15 and the piston shaft 16 in the speed regulating mechanism slide left and right along the shaft core line of the shaft body 9.

As compared to the existing CVT stepless speed changer, the stepless speed changer applied to a CVT gearbox provided by the present invention is same in function, creative in mechanism and superior in property:

function comparison: the two stepless speed chargers have the same functions, each integrating the functions of stepless speed change, pressurization and speed regulation into a whole;

mechanism comparison: (i) a transmission mechanism: the existing CVT transmission mechanism is of a parallel-shaft swash plate wheel type and adopts a symmetric speed-regulation mode, and its driving friction pair is a chain or steel belt, while the transmission mechanism of the present invention is of a coaxially planetary bevel-type and adopts a speed-raising speed regulation mode, and its driving friction pair includes two steel rings; (ii) a pressurization device: the existing CVT is a double-cylinder type, and pressurization is exerted by a spring hydraulic combination, while the pressurization device of the present invention is a single-cylinder type, and pressurization is exerted by a hydraulic pressure; and (iii) a speed regulating mechanism: the existing CVT adopts a mixed hydraulic speed regulation mode of a speed regulating mechanism and a pressurization device, while the speed regulating mechanism of the present invention adopts an independent multi-cylinder synchronous hydraulic speed regulation mode;

property comparison: (i) input torque: the existing CVT is 280 N·m or less, while it is 470-700 N·m in the present invention; (ii) gear ratio: the existing CVT is 7.6 or less, while it is 9.5 at the highest input torque in the present invention; and (iii) service time: the existing CVT is 300,000 kilometers, while it is indefinite in the present invention (i.e., as same as to the product life).

The present invention is not limited to the abovementioned embodiments. Any variation either in shape or material composition, as long as they make use of the structural design of the present invention, belongs to one transformation of the present invention, and thus shall be covered by the protection scope of the present invention.

1. A stepless speed changer, comprising a speed changing mechanism (31), a clamping mechanism (32), and a speed regulating mechanism (33), wherein the speed changing mechanism (31) is mounted on a shaft body (9) and the speed changing mechanism (31) is connected with a power input mechanism and a power output mechanism respectively along both sides of the shaft body (9); the clamping mechanism (32) is distributed along an axial direction of the shaft body (9) and located at both sides of the speed changing mechanism (31), and the clamping mechanism (32) guarantees that the speed changing mechanism (31) transmits a torque normally by use of pressurization of a first hydraulic system (43); the speed regulating mechanism (33) is located at a radial end of the shaft body (9) and combined with the speed changing mechanism (31), and the speed regulating mechanism (33) achieves speed change of the speed changing mechanism (31) by use of acceleration and deceleration control of a second hydraulic system (44).

2. The stepless speed changer of claim 1, wherein the speed changing mechanism (31) comprises an intermediate rolling body (34), an input frictional ring (3), an output frictional ring (6), an input flange (2) and an output flange (7) both mounted on the shaft body (9), a radial end face of the input frictional ring (3) is clamped between a radial end face of the intermediate rolling body (34) and an annular groove (35) disposed on the input flange (2), a radial end face of the output frictional ring (6) is clamped between the radial end face of the intermediate rolling body (34) and an annual groove (35) disposed on the output flange (7), and the input frictional ring (3) and the output frictional ring (6) are pressed between the annular grooves (35) of the input flange (2) and the output flange (7) and the intermediate rolling body (34) by the clamping mechanism (32).

3. The stepless speed changer of claim 2, wherein the intermediate rolling body (34) is of a split structure comprising an input pyramid wheel (4), an output pyramid wheel (5) and a splined cylinder liner (17), inner walls of the input pyramid wheel (4) and the output pyramid wheel (5) are provided with one turn of spline teeth (36) respectively, and the input pyramid wheel (4) and the output pyramid wheel (5) are connected into one piece by connection of the spline teeth (36) and the splined cylinder liner (17).

4. The stepless speed changer of claim 3, wherein the annular grooves (35) disposed on the input flange (2) and the output flange (7) are equal in diameter, and an outer diameter of a conical section of the input pyramid wheel (4) in contact with the input frictional ring (3) is smaller than an outer diameter of a conical section of the output pyramid wheel (5) in contact with the output frictional ring (6).

5. The stepless speed changer of claim 2, wherein the clamping mechanism (32) comprises a pressurization chamber (22) and a pressure disk (11) mounted on the shaft body (9), the pressurization chamber (22) is formed by sealingly assembling the pressure disk (11); the output flange (7) and fixedly connecting the pressure disk (11) and the output flange (7) by a thrust bearing and a bearing nut (13); the pressurization chamber (22) is in communication with a hydraulic opening (21) disposed on a radial wall of the shaft body (9), the hydraulic opening (21) is in communication with a hydraulic control opening (20) disposed on a through hole (37) through the through hole (37) disposed on a shaft core of the shaft body (9), and the hydraulic control opening (20) is controlled by the first hydraulic system (43).

6. The stepless speed changer of claim 5, wherein the thrust bearing is mounted on the shaft body (9) and comprises a left thrust bearing (10) and a right thrust bearing (12), the left thrust bearing (10) is limited at an input flange (2) end, and the right thrust bearing (12) is mounted at a pressure disk (11) end through a bearing bracket (38) and fixed through the bearing nut (13).

7. The stepless speed changer of claim 2, wherein the speed regulating mechanism (33) comprises an outer ring bracket (14), an inner hub bracket (15) and a piston shaft (16), the inner hub bracket (15) is mounted on the shaft body (9), the outer ring bracket (14) is mounted inside a housing (30), the piston shaft (16) is penetrated through the intermediate rolling body (34) shaft core, fixed between the outer ring bracket (14) and the inner hub bracket (15) by a bolt (19), and distributed in the form of an umbrella frame between the outer ring bracket (14) and the inner hub bracket (15).

8. The stepless speed changer of claim 7, wherein the piston shaft (16) is of cam shaft structure and divides the interior of the intermediate rolling body (34) into a deceleration control chamber (23) and an acceleration control chamber (24); one end of the piston shaft (16) is provided with a mounting hole for mounting of a cartridge valve (18), an internal channel of the cartridge valve (18) is in communication with the deceleration control chamber (23), and an acceleration control channel (27) between the cartridge valve (18) and the mounting hole is in communication with the acceleration control chamber (24).

9. The stepless speed changer of claim 8, wherein an acceleration control hydraulic opening (26) in communication with the acceleration control chamber (24) and a deceleration control hydraulic opening (25) in communication with the deceleration control chamber (23) are disposed on an outer wall of the outer ring bracket (14), each intermediate rolling body (34) corresponds to one acceleration control hydraulic opening (26) and one deceleration control hydraulic opening (25), and the control hydraulic openings are distributed annularly.

10. The stepless speed changer of claim 9, wherein two annular recesses (39) are disposed on the outer wall of the outer ring bracket (14) and the two annular recesses (39) are isolated from an inner wall of the housing (30) by three seals (40); the two annular recesses (39) correspond to the annularly-arranged acceleration control hydraulic opening (26) and deceleration control hydraulic opening (25) respectively, the housing (30) is provided with an acceleration control fluid interface (41) and a deceleration control fluid interface (42) in respective communication with the two annular recesses (39), and the interfaces are controlled by the second hydraulic system (44).
